(19) United States
(12) Patent Application Publication
(10) Pub. No.: US 2026/0281075 A1
(43) Pub. Date: Sep. 17, 2026

(54) Tunneling STUN Packets in the Presence of Endpoint-Dependent NAT

(71) Applicant: Arista Networks, Inc., Santa Clara, CA (US)

(72) Inventor: Anand Narayanan RAO, Bangalore (IN)

(21) Appl. No.: 19/081,324

(22) Filed: Mar. 17, 2025

(51) Int. Cl. H04L 61/2514; H04L 12/46

(52) U.S. Cl. CPC H04L 61/2514; H04L 12/4641; H04L 2212/00

(57) ABSTRACT

Techniques are provided for tunneling Session Traversal Utilities for NAT (STUN) packets between an edge device and a route reflector in a scenario where the edge device is behind an endpoint-dependent NAT (i.e., a NAT that performs different translations on network packets based on the destination of each packet). In certain embodiments, these techniques ensure that the route reflector learns/discovers “correct” public IP address/port information for the edge device in this scenario, or in other words public IP address/port information that enables the route reflector and the edge device to exchange tunneled data traffic.

### BACKGROUND

A typical SD-WAN (Software-Defined Wide Area Network) comprises edge devices that are distributed across different sites (e.g., branch offices, data centers, etc.) and are connected via service provider networks to a central route reflector (RR) residing in the cloud (e.g., the public Internet). The edge devices communicate with the RR via overlay tunnels, which abstract the underlying transport network and enable various SD-WAN features. Examples of overlay tunnel protocols that may be used for this purpose include Dynamic Path Selection (DPS), Inline Telemetry System (ITS), Virtual extensible Local Area Network (VXLAN), Generic Routing Encapsulation (GRE), and the like.

Because the edge devices are often deployed using private Internet Protocol (IP) addresses and private port numbers (which cannot be routed on the public Internet), a network address translation (NAT) layer residing in each service provider network intercepts the traffic exchanged between the edge devices and the RR and automatically translates each edge device's private IP address and private port into a corresponding public IP address and public port (and vice versa). To facilitate overlay tunnel establishment in the presence of this NAT layer, the edge devices and the RR engage in a protocol known as Session Traversal Utilities for NAT (STUN), which enables discovery of the edge devices' public IP address/port information.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example SD-WAN in accordance with certain embodiments of the present disclosure.

FIG. 2 depicts another example SD-WAN in accordance with certain embodiments of the present disclosure.

FIGS. 3A and 3B depict a STUN tunneling workflow in accordance with certain embodiments of the present disclosure.

FIGS. 4-7 depict example STUN packet encapsulation and decapsulation scenarios in accordance with certain embodiments of the present disclosure.

FIG. 8 depicts an example network device in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for tunneling STUN packets between an edge device and an RR in a scenario where the edge device is behind an endpoint-dependent NAT (i.e., a NAT that performs different translations on network packets based on the destination of each packet). In various embodiments, this tunneling is achieved by encapsulating the STUN packets within an overlay tunnel header corresponding to an overlay tunnel protocol used by the edge device and the RR for exchanging tunneled data traffic.

As explained in further detail below, by tunneling the STUN packets in this manner, the techniques of the present disclosure ensure that the RR learns/discovers “correct” public IP address/port information for the edge device in this scenario, or in other words public IP address/port information that enables the RR and the edge device to exchange tunneled data traffic.

### 1. Example SD-WAN

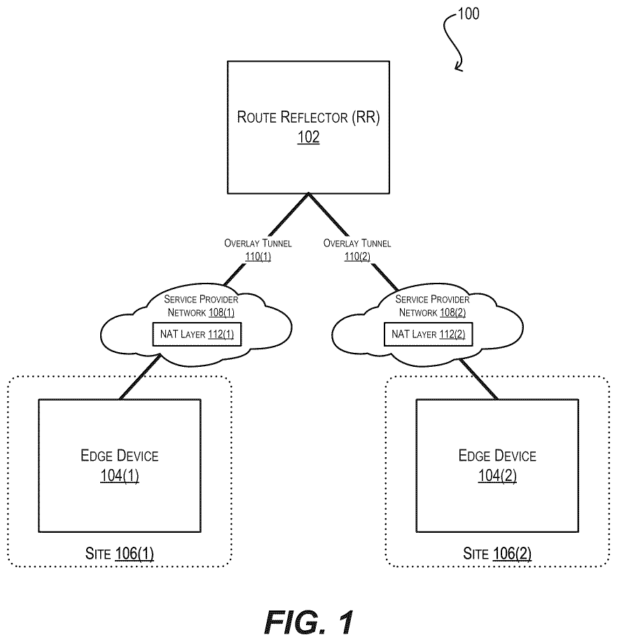

FIG. 1 is a simplified block diagram of an example SD-WAN 100 in which the techniques of the present disclosure may be implemented. As shown, SD-WAN 100 comprises a route reflector (RR) 102 that is communicatively coupled with a first edge device 104(1) at a first site 106(1) via a first service provider network 108(1) and with a second edge device 104(2) at a second site 106(2) via a second service provider network 108(2). Edge devices 104(1) and 104(2) are network devices, such as network routers, that are configured to receive and forward network traffic via a hardware-based data plane. RR 102 can be a network device or a general-purpose computer system/server. RR 102 is generally responsible for aggregating and distributing network routes, such as Border Gateway Protocol (BGP) routes, between the edge devices of SD-WAN 100, thereby avoiding the need for the edge devices to be peered with each other via a full-mesh topology.

Each edge device 104 connects to RR 102 via an overlay tunnel 110, which is a logical network connection that is established over an underlay (i.e., physical/transport) network. In the case of edge device 104(1) the underlay network between device 104(1) and RR 102 is service provider network 108(1) and in the case of edge device 104(2) the underlay network between device 104(2) and RR 102 is service provider network 108(2). The use of these overlay tunnels allows for secure communication between the edge device and the RR via, e.g., IP Security (IPsec) encryption and enables various SD-WAN features like application-aware routing, path optimization, and so on.

Further, because edge devices 104(1) and 104(2) are deployed within LANs at sites 106(1) and 106(2) that employ private IP addresses and private ports (which cannot be routed over the public Internet), a NAT layer 112 in each service provider network 108 intercepts the network traffic sent between the edge devices and RR 102 and automatically translates the edge device's private IP address and private port (as included in the headers of the intercepted traffic) into a public IP address and a public port, and vice versa. One consequence of this NAT mechanism is that RR 102 must discover/learn the public IP address/port information for each edge device 104 in order to establish an overlay tunnel with that edge device. This is typically achieved via a protocol known as STUN. The following is a conventional workflow that may be carried out between RR 102 and each edge device 104 of FIG. 1 in accordance with the STUN protocol:
1. A STUN client running on the edge device sends a STUN binding request packet to the RR via the service provider network connecting the edge device to the RR. The STUN binding request packet includes the edge device's private IP address and private port in the source IP address and source port fields of the packet's IP and User Datagram Protocol (UDP) headers. The STUN binding request packet also includes the predefined STUN server port number 3478 in the destination port field of the packet's UDP header.
2. The NAT layer in the service provider network intercepts the STUN binding request packet and translates the edge device's private IP address and private port (as included in the source IP address and source port fields) into a public IP address and a public port. As part of this translation process, the NAT layer modifies the STUN binding request packet's source IP address and source port fields to now include the public IP address and the public port (resulting in a “NAT-ed” version of the packet).
3. A STUN server running on the RR receives the NAT-ed STUN binding request packet, determines that the source IP address and source port included in the packet is the edge device's public IP address and public port, and sends a STUN binding response packet back to the edge device that (1) includes the edge device's public IP address and public port in the destination IP address and destination port fields of the packet's IP and UDP headers and (2) includes the edge device's public IP address and port in the packet's payload.
4. The NAT layer in the service provider network intercepts the STUN binding response packet and translates the edge device's public IP address and public port (as included in the destination IP address and destination port fields) into the edge device's private IP address and private port. As part of this translation process, the NAT layer modifies the STUN binding response packet's destination IP address and destination port fields to now include the private IP address and private port (resulting in a “deNAT-ed” version of the packet).
5. The STUN client on the edge device receives the deNAT-ed STUN binding response packet and learns its public IP address and public port from the packet's payload.

Upon receiving the STUN binding request packet from the edge device at step (3), the RR can establish an overlay tunnel with the edge device using the edge device's public IP address/port and can send tunneled data packets to the edge device via this overlay tunnel. In addition, upon receiving the STUN binding response packet from the RR at step (5), the edge device can register its public IP address and public port with the RR. The RR can then propagate the edge device's public IP address/port information to other edge devices in the SD-WAN, thereby enabling the establishment of direct site-to-site tunnels between those edge devices.

Notably, once the overlay tunnel is established between the edge device and the RR, the edge device will transmit tunneled data packets to the RR via a different destination port than the STUN binding request packet. For example, if the overlay tunnel is a DPS or ITS tunnel, the edge device will transmit tunneled data packets to the destination port number 4793. As another example, if the overlay tunnel is encrypted using IPsec, the edge device will transmit tunneled data packets to the destination port number 4500.

### 2. Problem Statement

One limitation of the STUN protocol workflow above is that it assumes the NAT layer in the service provider network is endpoint independent. An endpoint-independent NAT is a type of NAT that always performs the same translation on a network packet, regardless of the destination (i.e., destination IP address and destination port) of the packet. In contrast, an endpoint-dependent NAT performs different translations on network packets based on each packet's destination IP address and destination port. For example, assume an endpoint-dependent NAT receives two packets from an edge device, a first packet with a source IP address of AAA.AAA.AAA.AAA, a destination IP address of BBB.BBB.BBB.BBB, a source port of 1111, and a destination port of 2222, and a second packet with a source IP address of AAA.AAA.AAA.AAA, a destination IP address of CCC.CCC.CCC.CCC, a source port of 1111, and a destination port of 3333. In this scenario, the translations performed by an endpoint-dependent NAT on these two packets will result in a different source (public/NAT-ed) IP address and source (public/NAT-ed) port for each packet, because they specify two different destinations.

The assumption that the service provider NAT layer is endpoint-independent in the STUN protocol workflow ensures that the public IP address and public port learned by the RR for the edge device remains valid for exchanging tunneled data packets over the established overlay tunnel (which will be sent to a different destination port than the STUN binding request packet, as mentioned above). This is because the translation performed by an endpoint-independent NAT with respect to the STUN binding request packet will be the same translation performed with respect to tunneled data packets, even though the STUN binding request packet and the tunneled data packets are sent to different destination ports.

However, it is becoming increasingly common for service providers to implement endpoint-dependent NATs in their networks. If the service provider NAT layer is endpoint-dependent, the translation it performs with respect to the STUN binding request packet will necessarily be different (or in other words, result in a different NAT-ed IP address and port) than the translation it performs with respect to tunneled data packets, because the destination ports for these two packet types are different. Accordingly, the public IP address and public port learned by the RR for the edge device will be incorrect for tunneling purposes and thus will prevent the RR from communicating with the edge device via an overlay tunnel.

### 3. Solution Overview

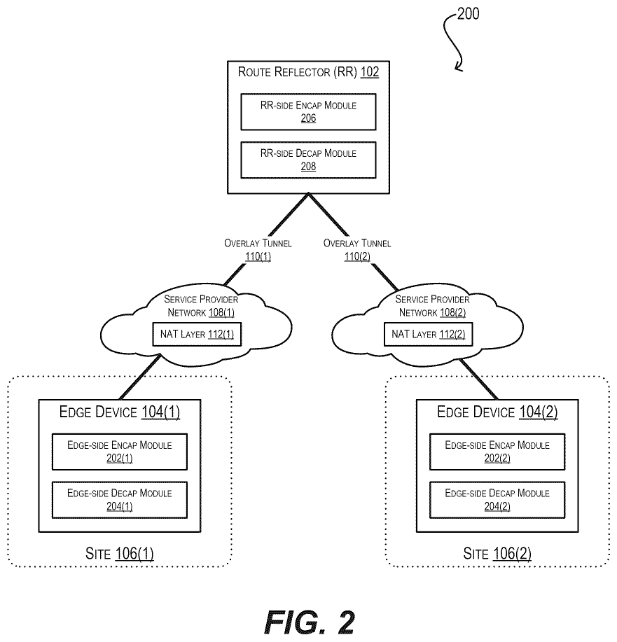

To address the foregoing and other similar problems, FIG. 2 depicts an enhanced version 200 of SD-WAN 100 of FIG. 1 that implements a novel framework for tunneling the STUN packets exchanged between each edge device 104 and RR 102 via the overlay tunnel protocol used for normal tunneled data traffic between these two entities, such that the NAT layer in the intervening service provider network (which is assumed to be endpoint-dependent) performs the same translation on the tunneled STUN packets as normal tunneled data packets. As shown in FIG. 2, this framework comprises new edge-side encapsulation and decapsulation modules 202 and 204 in each edge device 104 and new RR-side encapsulation and decapsulation modules 206 and 208 in RR 102. Modules 202/204 and 206/208 can be implemented via software or hardware within the data plane of each edge device 104 and RR 102 respectively.

With this novel framework, a number of benefits are realized. First, the framework enables the RR to discover/learn, via the STUN protocol workflow described previously, the “correct” public IP address and public port of each edge device, where this correct public IP address/port corresponds to the NAT-ed IP address/port determined by the endpoint-dependent NAT layer for tunneled data packets (rather than the NAT-IP IP address/port determined by the endpoint-dependent NAT layer for conventional STUN packets).

Second, the framework does not require any changes to the STUN client running on the edge device or the STUN server running on the RR; the tunneling of STUN packets performed by modules 202/204 and 206/208 is completely transparent to these STUN protocol components.

Third, the framework works (i.e., results in correct behavior) in the case where an edge device is behind an endpoint-independent NAT and thus does not need to be selectively deployed; instead, it can be deployed in a wholesale manner through an SD-WAN, regardless of the specific NAT type (endpoint-independent or endpoint-dependent) implemented in the associated service provider networks.

Fourth, the framework works for both IPsec-encrypted overlay tunnels and non-IPsec (i.e., unencrypted) overlay tunnels.

The remaining sections of the present disclosure describe the operation of the framework in detail, along with a mechanism for differentiating encapsulated STUN packets from IPsec control packets (for SD-WANs in which IPsec encrypted overlay tunnels are used). It should be appreciated that FIGS. 1 and 2 and the foregoing high-level solution description are illustrative and not intended to be limiting. For example, Although FIGS. 1 and 2 depict a particular arrangement of entities in SD-WAN 100/200, other arrangements are possible (e.g., the functionality attributed to a particular entity may be split into multiple entities, entities may be combined, etc.). One of ordinary skill in the art will recognize other similar modifications, variations, and alternatives.

### 4. STUN Tunneling Workflow

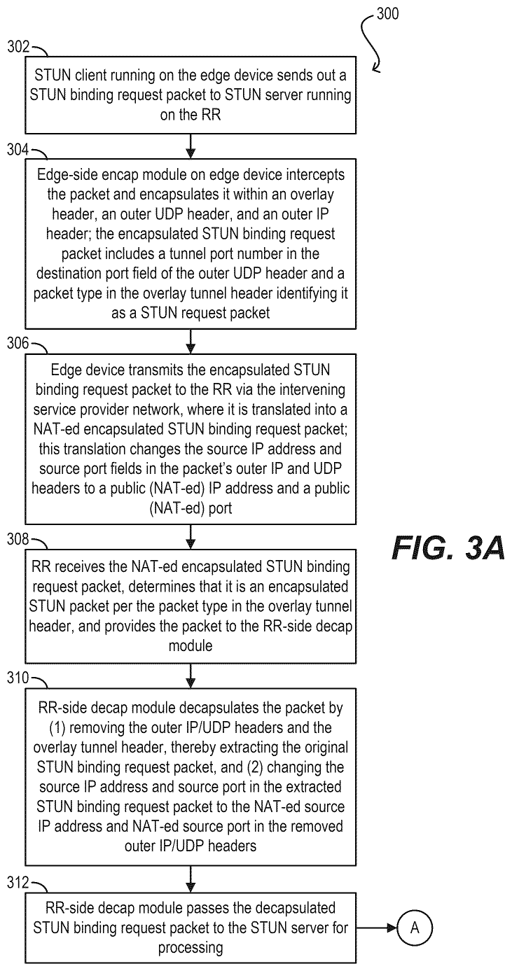

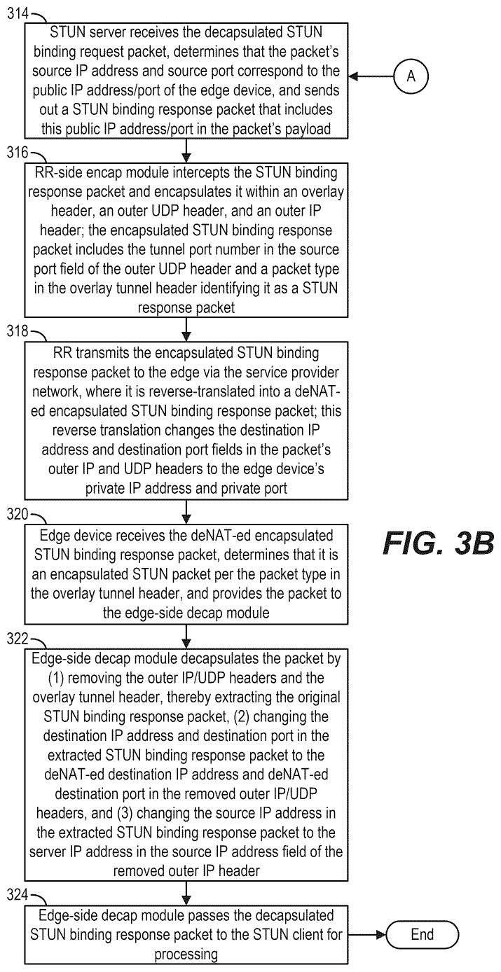

FIGS. 3A and 3B depict a workflow 300 that may be executed by RR 102 and each edge device 104 of SD-WAN 200 of FIG. 2 for tunneling STUN packets in accordance with the framework of the present disclosure.

Starting with step 302 of FIG. 3A, the STUN client running on edge device 104 can send out a STUN binding request packet to the STUN server running on RR 102.

At step 304, edge-side encapsulation module 202 on edge device 104 can intercept the STUN binding request packet and encapsulate it within an overlay tunnel header, an outer UDP header, and an outer IP header. The encapsulated STUN binding request packet can include the tunnel port number required by the overlay tunnel protocol used between edge device 104 and RR 102 in the destination port field of its outer UDP header. In the case of DPS/ITS this tunnel port number is 4793 and in the case of IPsec-encrypted tunnels this tunnel port number is 4500. In addition, the encapsulated STUN binding request packet can include a packet type of “Stun-Request” in its overlay tunnel header. This packet type indicates that the encapsulated inner packet is a STUN binding request packet.

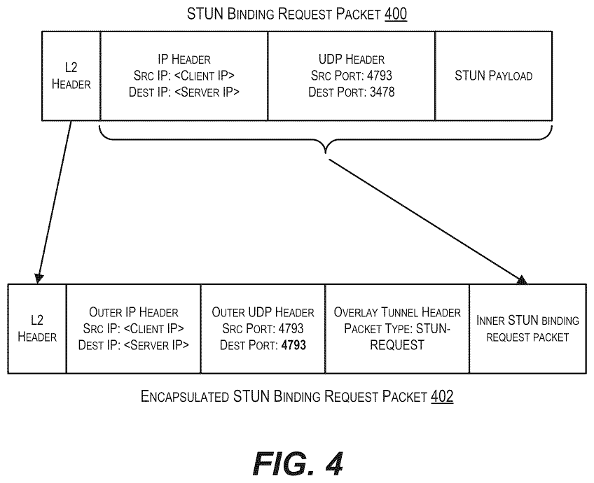

By way of example, FIG. 4 depicts a STUN binding request packet 400 and an encapsulated version 402 of the packet that has been encapsulated per step 304.

At step 306, edge device 104 can transmit the encapsulated STUN binding request packet to RR 102 via intervening service provider network 108, where it is translated into a NAT-ed encapsulated STUN binding request packet by the service provider network's endpoint-dependent NAT layer 112. This translation changes the source IP address and source port fields in the NAT-ed packet's outer IP and UDP headers to a public (NAT-ed) IP address and a public (NAT-ed) port, based on the destination specified in the original encapsulated STUN binding request packet.

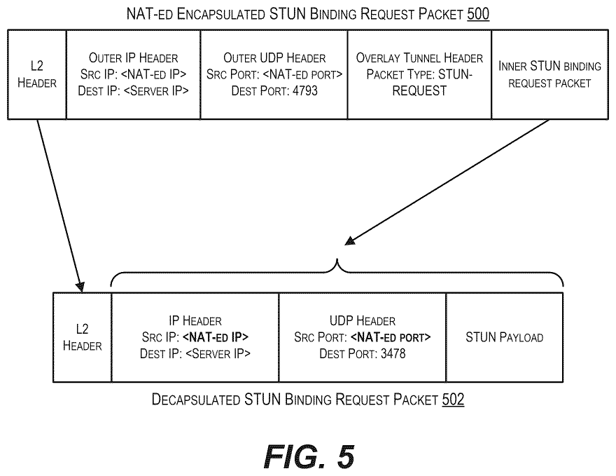

At step 308, RR 102 can receive the NAT-ed encapsulated STUN binding request packet, determine that it is an encapsulated STUN packet by virtue of the packet type field in the packet's overlay tunnel header, and provides the packet to RR-side decapsulation module 208. In response, RR-side decapsulation module 208 can decapsulate the packet by (1) removing the outer IP/UDP headers and the overlay tunnel header added at step 304, thereby extracting the original (inner) STUN binding request packet, and (2) changing the source IP address and source port in the IP and UDP headers of the extracted STUN binding request packet to the NAT-ed source IP address and NAT-ed source port specified in the removed outer IP/UDP headers of the NAT-ed packet (step 310). By way of example, FIG. 5 depicts a NAT-ed encapsulated STUN binding request packet 500 and a decapsulated version 502 of the packet that has been decapsulated per step 310.

RR-side decapsulation module 208 can then pass the decapsulated STUN binding request packet to the RR's STUN server for processing (step 312).

Turning now to FIG. 3B, at step 314, the STUN server running on RR 102 can receive the decapsulated STUN binding request packet, determine that the source IP address and source port included in the packet's IP and UDP headers are the public IP address and public port for edge device 104, and send out a STUN binding response packet to the edge device's STUN client. This STUN binding response packet can include in its payload the edge device's public IP address and public port (which is the NAT-ed IP address and NAT-ed port for the edge device as translated by endpoint-dependent NAT layer 112 with respect to the destination tunnel port).

At step 316, RR-side encapsulation module 206 on RR 102 can intercept the STUN binding response packet and encapsulate it within an overlay tunnel header, an outer UDP header, and an outer IP header. The encapsulated STUN binding response packet can include the tunnel port number required by the overlay tunnel protocol used between edge device 104 and RR 102 (e.g., 4793 for DPS/ITS or 4500 for IPsec) in the source port field of its outer UDP header. In addition, the encapsulated STUN binding response packet can include a packet type of “Stun-Response” in its overlay tunnel header. This packet type indicates that the encapsulated inner packet is a STUN binding response packet.

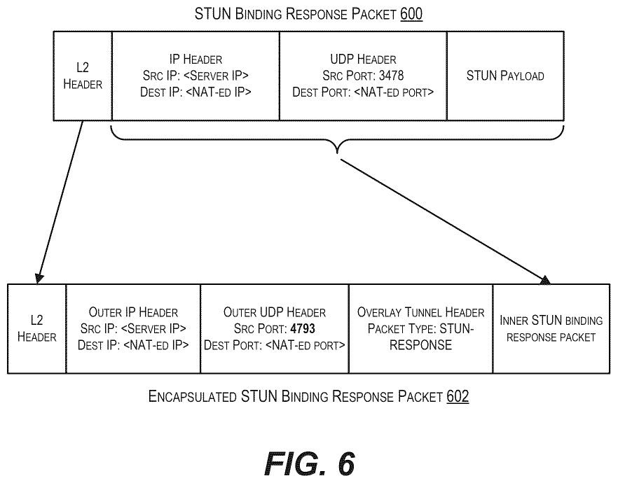

By way of example, FIG. 6 depicts a STUN binding response packet 600 and an encapsulated version 602 of the packet that has been encapsulated per step 316.

At step 318, RR 102 can transmit the encapsulated STUN binding response packet to edge device 104 via intervening service provider network 108, where it is reverse-translated (or in other words, deNAT-ed) into a deNAT-ed encapsulated STUN binding response packet by the service provider network's endpoint-dependent NAT layer 112. This reverse translation changes the destination IP address and destination port fields in the deNAT-ed packet's outer IP and UDP headers to the corresponding private IP address and private port of the edge device.

At step 320, edge device 104 can receive the deNAT-ed encapsulated STUN binding response packet, determine that it is an encapsulated STUN packet by virtue of the packet type field in the packet's overlay tunnel header, and forward the packet to edge-side decapsulation module 204. In response, edge-side decapsulation module 204 can decapsulate the packet by (1) removing the outer IP/UDP headers and the overlay tunnel header added at step 316, thereby extracting the original (inner) STUN binding response packet, (2) changing the destination IP address and destination port in the IP and UDP headers of the extracted STUN binding response packet to the deNAT-ed destination IP address and deNAT-ed destination port specified in the removed outer IP/UDP headers of the deNAT-ed packet, and (3) changing the source IP address in the IP header of the extracted STUN binding response packet to source (server) IP address specified in the source IP address field of the removed outer IP header of the deNAT-ed packet (step 322). (3) is needed for cases where the STUN server is behind a static NAT; in such cases, the original STUN binding response packet will include the STUN server's private IP address in the source IP address field, which would be incorrect from the perspective of the STUN client.

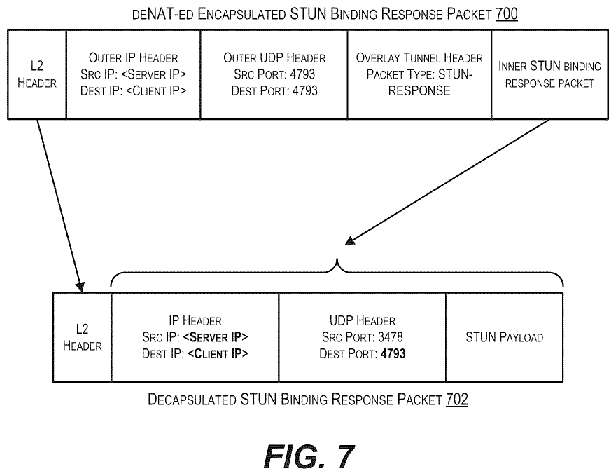

By way of example, FIG. 7 depicts a deNAT-ed encapsulated STUN binding response packet 700 and a decapsulated version 702 of the packet that has been decapsulated per step 322.

Finally, at step 324, edge-side decapsulation module 204 can pass the decapsulated STUN binding response packet to the edge device's STUN client for processing and the workflow can end.

5. Differentiating Encapsulated STUN Packets from IPsec Control (IKE) Packets

Internet Key Exchange (IKE) is a control protocol used by IPsec for establishing secure connections between IPsec peers and exchanging cryptographic keys between those peers. In a scenario where IPsec is used to encrypt the overlay tunnels between the RR and the edge devices in the solution above, both encapsulated STUN packets and IKE packets will be sent to the same destination port number of 4500. This is problematic because the receiving device (e.g., the RR or the edge device) cannot easily differentiate between these two types of packets.

To address this problem in certain embodiments the RR-side and edge-side encapsulation modules can employ a novel format for encapsulated STUN binding request/response packets that clearly distinguishes these packets from IKE packets. To understand the rationale behind this new format, the following table presents the standard IKE (v2) header format per Request for Comments (RFC) 7296:

TABLE 1

IP Header
UDP Header
4 bytes of 0 values
IKE SA (Security Association) Initiator's SPI (8 bytes)
IKE SA Responder's SPI (8 bytes)
. . .

As can be seen above, the IKE header itself starts at the fourth row, after four bytes of 0 (zero) values following the UDP header. RFC 7296 states that the IKE SA Initiator's SPI field (which comprises the eight bytes following the four bytes of 0 values) cannot be zero.

With this in mind, the following table presents the format for an encapsulated STUN packet in accordance with certain embodiments of the present disclosure:

TABLE 2

Outer IP Header
Outer UDP Header
4 bytes of 0 values
8 bytes of 0 values
Overlay Tunnel Header
STUN Payload

As can be seen above, there are twelve consecutive bytes of 0 values following the outer UDP header in this format, which is not possible in an IKE packet (because the IKE SA Initiator's field must be non-zero). Accordingly, at the time the RR or edge device receives a packet on port 4500, the device can first check for the presence of these twelve consecutive 0 values after the outer UDP header. If found, the device can proceed to check for the STUN packet type in the overlay tunnel header and process the packet as an encapsulated STUN packet as described in the previous section. Alternatively, if the twelve consecutive zero values are not found after the outer UDP header, the device can process the packet as an IKE packet.

It should be noted that, in IPsec data and keepalive packets (which are distinct from IKE packets), the four bytes following the UDP header are always non-zero. Thus, these IPsec data/keepalive packets can also be differentiated from STUN packets that are encapsulated via the format shown in Table 2 (which will always have four bytes of 0s after the outer UDP header).

### 6. Example Network Device

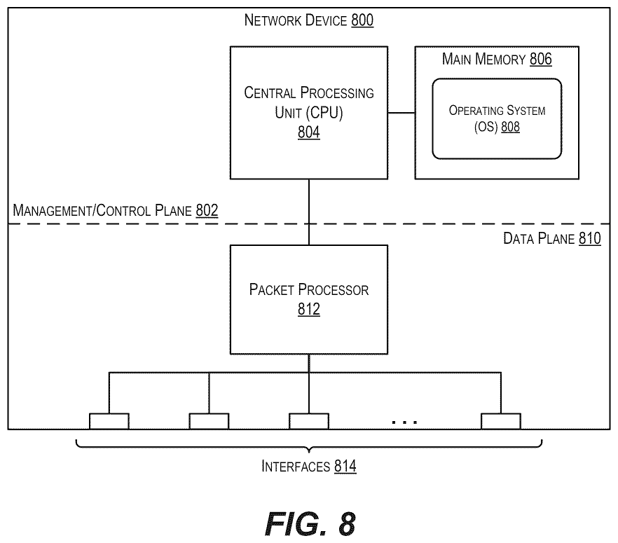

FIG. 8 is a simplified block diagram of an example network device (e.g., switch or router) 800 according to certain embodiments. Network device 800 may be used to implement RR 102 and/or edge devices 104(1) and 104(2) of FIGS. 1 and 2.

As shown in FIG. 8, network device 800 comprises a management/control plane 802 including a central processing unit (CPU) 804 and a main memory 806 (e.g., random-access memory (RAM)). CPU 804 is a general-purpose processor that is responsible for managing the configuration/operation of network device 800 and controlling the device's understanding of the network in which it resides. CPU 804 carries out these functions under the direction of an operating system (OS) 808 that runs on CPU 804 from main memory 806.

Network device 800 also comprises a data plane 810 including a packet processor 812 and a set of front-panel interfaces (i.e., ports) 814. Packet processor 812 is typically an integrated circuit, such as an application-specific integrated circuit (ASIC) or a field-programmable gate array (FPGA), that is responsible for performing line-speed processing of network traffic that passes through network device 800 via front-panel interfaces 814. This line-speed processing can include, for example, Layer 2 (L2) bridging and Layer 3 (L3) routing of network packets. In certain embodiments, packet processor 812 (or some other component in data plane 810) can be configured to carry out the encapsulation and decapsulation of STUN packets described in the foregoing sections.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by an edge network device in a Software-Defined Wide Area Network (SD-WAN), the method comprising:
receiving, from a Session Traversal Utilities for Network Address Translation (STUN) client running on the edge network device, a STUN binding request packet destined for a STUN server running on a route reflector of the SD-WAN;
encapsulating the STUN binding request packet within an overlay tunnel header, an outer Internet Protocol (IP) header, and an outer User Datagram Protocol (UDP) header, the encapsulated STUN binding request packet including:
a tunnel port in a destination port field of the outer UDP header, wherein the tunnel port is used for communication between the edge network device and the route reflector via an overlay tunnel; and
a first packet type in a packet type field of the overlay tunnel header, the first packet type indicating that the encapsulated STUN binding request packet is a STUN protocol packet; and
transmitting the encapsulated STUN binding request packet to the route reflector via a service provider network.

2. The method of claim 1 wherein the overlay tunnel is encrypted using Internet Protocol Security (IPsec) and wherein the encapsulated STUN binding request packet includes twelve bytes of zero values between the outer UDP header and the overlay tunnel header.

3. The method of claim 1 wherein a network address translation (NAT) layer in the service provider network:
intercepts the encapsulated STUN binding request packet;
translates the encapsulated STUN binding request packet into a NAT-ed encapsulated STUN binding request packet, the translating comprising:
changing a private IP address of the edge network device specified in a source IP address field of the outer IP header to a public IP address of the edge network device; and
changing a private port of the edge network device specified in a source port field of the outer UDP header to a public port of the edge network device; and
forwards the NAT-ed encapsulated STUN binding request packet to the route reflector.

4. The method of claim 3 wherein the NAT layer is an endpoint-dependent NAT.

5. The method of claim 3 wherein the route reflector:
receives the NAT-ed encapsulated STUN binding request packet;
determines that the received packet is an encapsulated STUN protocol packet by:
checking for presence of twelve bytes of zero values between the outer UDP header and the overlay tunnel header in a scenario where the overlay tunnel is encrypted using IPsec; and
checking the packet type field in the overlay tunnel header;
extracts, from the received packet, the STUN binding request packet originally sent by the STUN client by:
removing the outer IP header;
removing the outer UDP header;
removing the overlay tunnel header; and
removing the twelve bytes of zero values between the outer UDP header and the overlay tunnel header in the scenario where the overlay tunnel is encrypted using IPsec;
modifies a source IP address of the extracted STUN binding request packet to the public IP address included in the source IP address field of the removed outer IP header;
modifies a source port of the extracted STUN binding request packet to the public port included in the source port field of the removed outer UDP header; and
passes the modified STUN binding request packet to the STUN server for processing.

6. The method of claim 5 wherein the STUN server:
receives the modified STUN binding request packet;
determines that the source IP address and the source port of the modified STUN binding request packet correspond to the edge network device's public IP address and public port; and
sends out a STUN binding response packet that includes the edge network device's public IP address and public port in a payload of the STUN binding response packet.

7. The method of claim 6 wherein the route reflector:
receives the STUN binding response packet from the STUN server;
encapsulates the STUN binding response packet within a second overlay tunnel header, a second outer IP header, and a second outer UDP header, the encapsulated STUN binding response packet including:
the tunnel port in a source port field of the second outer UDP header; and
a second packet type in a packet type field of the second overlay tunnel header, the second packet type indicating that the encapsulated STUN binding response packet is a STUN protocol packet; and
transmits the encapsulated STUN binding response packet to the edge network device via the service provider network,
wherein the encapsulated STUN binding response packet includes twelve bytes of zero values between the second outer UDP header and the second overlay tunnel header in the scenario where the overlay tunnel is encrypted using IPsec.

8. The method of claim 7 wherein the NAT layer:
intercepts the encapsulated STUN binding response packet;
reverse-translates the encapsulated STUN binding response packet into a deNAT-ed encapsulated STUN binding request packet, the reverse-translating comprising:
changing a destination IP address specified in a destination IP address field of the second outer IP header to the private IP address of the edge network device; and
changing a destination port specified in a destination port field of the second outer UDP header to the private port of the edge network device; and
forwards the deNAT-ed encapsulated STUN binding response packet to the edge network device.

9. The method of claim 8 wherein the edge network device:
receives the deNAT-ed encapsulated STUN binding response packet;
determines that the received packet is an encapsulated STUN protocol packet by:
checking for presence of twelve bytes of zero values between the second outer UDP header and the second overlay tunnel header in the scenario where the overlay tunnel is encrypted using IPsec; and
checking the packet type field in the second overlay tunnel header;
extracts, from the received packet, the STUN binding response packet originally sent by the STUN server by:
removing the second outer IP header;
removing the second outer UDP header;
removing the second overlay tunnel header; and
removing the twelve bytes of zero values between the second outer UDP header and the second overlay header in the scenario where the overlay tunnel is encrypted using IPsec;
modifies a destination IP address of the extracted STUN binding response packet to the private IP address included in the destination IP address field of the removed second outer IP header;
modifies a destination port of the extracted STUN binding response packet to the private port included in the destination port field of the removed second outer UDP header;
modifies a source IP address of the extracted STUN binding response packet to a server IP address specified in a source IP address field of the removed second outer IP header; and
passes the modified STUN binding response packet to the STUN client for processing.

10. An edge network device that is part of a Software-Defined Wide Area Network (SD-WAN), the edge network device comprising:
a processor; and
a memory having stored thereon program code that, when executed by the processor, causes the processor to:
receive, from a Session Traversal Utilities for Network Address Translation (STUN) client running on the edge network device, a STUN binding request packet destined for a STUN server running on a route reflector of the SD-WAN;
encapsulate the STUN binding request packet within an overlay tunnel header, an outer Internet Protocol (IP) header, and an outer User Datagram Protocol (UDP) header, the encapsulated STUN binding request packet including:
a tunnel port in a destination port field of the outer UDP header, wherein the tunnel port is used for communication between the edge network device and the route reflector via an overlay tunnel; and
a first packet type in a packet type field of the overlay tunnel header, the first packet type indicating that the encapsulated STUN binding request packet is a STUN protocol packet; and
transmit the encapsulated STUN binding request packet to the route reflector via a service provider network.

11. The edge network device of claim 10 wherein the overlay tunnel is encrypted using Internet Protocol Security (IPsec) and wherein the encapsulated STUN binding request packet includes twelve bytes of zero values between the outer UDP header and the overlay tunnel header.

12. The edge network device of claim 10 wherein a network address translation (NAT) layer in the service provider network:
intercepts the encapsulated STUN binding request packet;
translates the encapsulated STUN binding request packet into a NAT-ed encapsulated STUN binding request packet, the translating comprising:
changing a private IP address of the edge network device specified in a source IP address field of the outer IP header to a public IP address of the edge network device; and
changing a private port of the edge network device specified in a source port field of the outer UDP header to a public port of the edge network device; and
forwards the NAT-ed encapsulated STUN binding request packet to the route reflector.

13. The edge network device of claim 12 wherein the NAT layer is an endpoint-dependent NAT.

14. The edge network device of claim 12 wherein the route reflector:
receives the NAT-ed encapsulated STUN binding request packet;
determines that the received packet is an encapsulated STUN protocol packet by:
checking for presence of twelve bytes of zero values between the outer UDP header and the overlay tunnel header in a scenario where the overlay tunnel is encrypted using IPsec; and
checking the packet type field in the overlay tunnel header;
extracts, from the received packet, the STUN binding request packet originally sent by the STUN client by:
removing the outer IP header;
removing the outer UDP header;
removing the overlay tunnel header; and
removing the twelve bytes of zero values between the outer UDP header and the overlay tunnel header in the scenario where the overlay tunnel is encrypted using IPsec;
modifies a source IP address of the extracted STUN binding request packet to the public IP address included in the source IP address field of the removed outer IP header;
modifies a source port of the extracted STUN binding request packet to the public port included in the source port field of the removed outer UDP header; and
passes the modified STUN binding request packet to the STUN server for processing.

15. The edge network device of claim 14 wherein the STUN server:
receives the modified STUN binding request packet;
determines that the source IP address and the source port of the modified STUN binding request packet correspond to the edge network device's public IP address and public port; and
sends out a STUN binding response packet that includes the edge network device's public IP address and public port in a payload of the STUN binding response packet.

16. The edge network device of claim 15 wherein the route reflector:
receives the STUN binding response packet from the STUN server;
encapsulates the STUN binding response packet within a second overlay tunnel header, a second outer IP header, and a second outer UDP header, the encapsulated STUN binding response packet including:
the tunnel port in a source port field of the second outer UDP header; and
a second packet type in a packet type field of the second overlay tunnel header, the second packet type indicating that the encapsulated STUN binding response packet is a STUN protocol packet; and
transmits the encapsulated STUN binding response packet to the edge network device via the service provider network,
wherein the encapsulated STUN binding response packet includes twelve bytes of zero values between the second outer UDP header and the second overlay tunnel header in the scenario where the overlay tunnel is encrypted using IPsec.

17. The edge network device of claim 16 wherein the NAT layer:
intercepts the encapsulated STUN binding response packet;
reverse-translates the encapsulated STUN binding response packet into a deNAT-ed encapsulated STUN binding request packet, the reverse-translating comprising:
changing a destination IP address specified in a destination IP address field of the second outer IP header to the private IP address of the edge network device; and
changing a destination port specified in a destination port field of the second outer UDP header to the private port of the edge network device; and
forwards the deNAT-ed encapsulated STUN binding response packet to the edge network device.

18. The edge network device of claim 17 wherein edge network device:
receives the deNAT-ed encapsulated STUN binding response packet;
determines that the received packet is an encapsulated STUN protocol packet by:
checking for presence of twelve bytes of zero values between the second outer UDP header and the second overlay tunnel header in the scenario where the overlay tunnel is encrypted using IPsec; and
checking the packet type field in the second overlay tunnel header;
extracts, from the received packet, the STUN binding response packet originally sent by the STUN server by:
removing the second outer IP header;
removing the second outer UDP header;
removing the second overlay tunnel header; and
removing the twelve bytes of zero values between the second outer UDP header and the second overlay header in the scenario where the overlay tunnel is encrypted using IPsec;
modifies a destination IP address of the extracted STUN binding response packet to the private IP address included in the destination IP address field of the removed second outer IP header;
modifies a destination port of the extracted STUN binding response packet to the private port included in the destination port field of the removed second outer UDP header;
modifies a source IP address of the extracted STUN binding response packet to a server IP address specified in a source IP address field of the removed second outer IP header; and
passes the modified STUN binding response packet to the STUN client for processing.

19. A method performed by a route reflector in a Software-Defined Wide Area Network (SD-WAN), the method comprising:
receiving a Network Address Translation (NAT)-ed encapsulated Session Traversal Utilities for NAT (STUN) binding request packet;
determining that the received packet is an encapsulated STUN protocol packet by checking a packet type field in an overlay tunnel header in the received packet;
extracting, from the received packet, a STUN binding request packet originally sent by a STUN client running on an edge network device by:
removing an outer Internet Protocol (IP) header;
removing an outer User Datagram Protocol (UDP) header; and
removing the overlay tunnel header;
modifying a source IP address of the extracted STUN binding request packet to a public IP address included in a source IP address field of the removed outer IP header;
modifying a source port of the extracted STUN binding request packet to a public port included in a source port field of the removed outer UDP header; and
passing the modified STUN binding request packet to a STUN server running on the route reflector for processing.

20. The method of claim 19 wherein an overlay tunnel between the route reflector and the edge network device is encrypted using Internet Protocol Security (IPsec), wherein determining that the received packet is an encapsulated STUN protocol packet further comprises checking for presence of twelve bytes of zero values between the outer UDP header and the overlay tunnel header, and wherein extracting the STUN binding request packet further comprises removing the twelve bytes of zero values.
